(19) United States
(12) Patent Application Publication
(10) Pub. No.: US 2004/0003369 A1
(43) Pub. Date: Jan. 1, 2004

(54) Object-oriented system estimation

(76) Inventor: Dan G. Gonos, Folsom, CA (US)

Correspondence Address: FISH & RICHARDSON P.C., 1425 K STREET, N.W., 11TH FLOOR, WASHINGTON, DC, 20005-3500, US

(21) Appl. No.: 10/179,018

(22) Filed: Jun. 26, 2002

(51) Int. Cl. G06F 9/44

(52) U.S. Cl. 717/100

(57) ABSTRACT

A calibration model that associates a level of effort associated with a discrete aspect or activity and information gathered from functional, technical, or management work products are used to generate estimate models for an object-oriented system. The data used to generate the estimate models may be adjusted repeatedly as more information becomes available.

### TECHNICAL FIELD

This description relates to techniques for estimating the human effort required for developing an object-oriented application program for a computer system.

### BACKGROUND

During the planning, delivery, and installation of an application program for a computer system, such as a product lifecycle management system, an enterprise resource management system, a financial management system, a human resources management system, or a supply chain management system, an estimate of the human effort required may be determined. The estimate of the human effort required may be measured in the amount of time required for a person to accomplish the work (such as person-months or person-days). Estimates may be performed by a person making a reasoned judgment based on the system information available to that person. This is sometimes referred to as an expert judgment approach.

Techniques for estimating the human effort required for developing an application program may be applied to the work product produced or the activities performed when using a waterfall model for developing an application program. A waterfall model assumes that application development sequentially proceeds lockstep through the stages of analysis, design, coding, and testing.

### SUMMARY

In one general aspect, estimating a level of effort required for developing an object-oriented application program includes receiving at one or more computer systems estimating information and one or more level of effort estimates, with each level of effort estimate being associated with an aspect or activity associated with developing an object-oriented application program. The received level of effort estimates are accumulated using at least one of the computer systems, and one or more estimate models are generated using the accumulated level of effort estimates and at least one of the computer systems. The accumulating of the level of effort estimates and the generating of the estimate models are repeated as more estimating information is provided.

Implementations may include one or more of the following features. For example, generating one or more estimating models may include generating an application estimate model, a business estimate model, an information model estimate model, a security estimate model, an infrastructure estimate model, a system management estimate model, or an enterprise estimate model. An application estimate model may include a business rule services model, a visual services model, a data exchange services model, a user session services model, a commercial-off-the-shelf interface services model, a World Wide Web services model, or a decision support services model.

A level of effort estimate may be associated with developing an object class, a method associated with an object class, a visual interface, a window for a visual interface, an interface to a computer system, or a component of an information model. A level of effort estimate may be associated with conducting a design session, operating an offline program, defining a security policy, or configuring a device to provide security for the device. A level of effort estimate may be associated with configuring, managing, or monitoring a device. A level of effort estimate may be associated with engineering, designing, or implementing one or more network devices for a site. A level of effort estimate may be associated with performing configuration management for a device, with one or more of repairing, replacing, moving, or adding a device, or with modifying the configuration of a device. A level of effort estimate may be associated with providing security for a collection of information, a site, or a device. During the planning, delivery, and installation of a new object-oriented system, an estimate of the amount of human effort required to develop the system may be needed. Object-oriented system estimates often may be made based using a waterfall model for application development even when the work products produced and the activities performed for object-oriented system development are different than the work products produced and the activities performed for development using a waterfall model.

The accuracy of object-oriented system estimates may be improved when estimates are made based on descriptions of the work product to be produced and the activities to be performed when developing an object-oriented system. For example, the accuracy of object-oriented system estimates may be improved when object-oriented system information (such as object class information, use case information, visual interface information, and device information) is used to generate one or more estimate models. Increasing the types and variety of estimate models generated may result in more accurate estimates.

Object-oriented system information that is collected and estimate models that are produced may be used throughout the planning, delivery, and installation of an object-oriented system. The estimate models may be revised as additional information is collected or expert judgment is applied. Improved accuracy in object-oriented system estimates may result in reduced risk of failure when developing an object-oriented system.

Implementations of the techniques discussed above may include a method or a process, a system or an apparatus, or computer software on a computer-accessible medium.

The details of one or more of the implementations are set forth in the accompanying drawings and description below. Other features will be apparent from the description and drawings, and from the claims.

### DESCRIPTION OF THE DRAWINGS

FIG. 1 is a block diagram illustrating an exemplary computer system capable of implementing an object-oriented system estimation process.

FIG. 2 is a flow chart of a process for developing an estimate model for an object-oriented system.

FIG. 3 is a block diagram of the components of a software architecture for an object-oriented system estimation process.

FIGS. 4-10 are flow charts of processes for developing estimate models for an object-oriented system.

FIG. 11 is a block diagram illustrating a result of an object-oriented application estimating process.

Like reference symbols in the various drawings indicate like elements.

### DETAILED DESCRIPTION

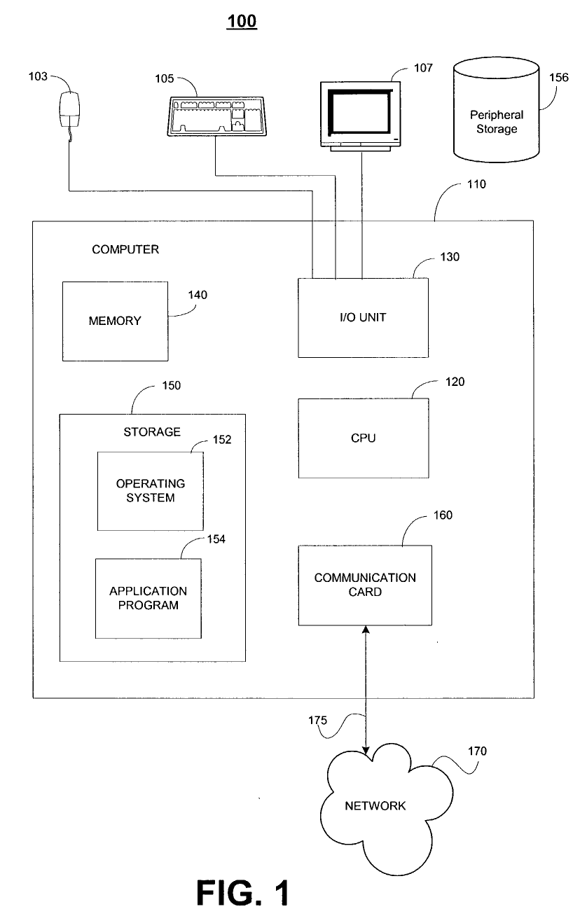

Referring to FIG. 1, a programmable system 100 for estimating the amount of human effort required to develop an object-oriented system includes a variety of input/output (I/O) devices (e.g., mouse 103, keyboard 105, and display 107) and a computer 110 having a central processor unit (CPU) 120, an I/O unit 130, a memory 140, and a data storage device 150. Data storage device 150 may store machine-executable instructions, data, and various programs such as an operating system 152 and one or more application programs 154 for implementing an object-oriented system estimation process, all of which may be processed by CPU 120. Each computer program may be implemented in a high-level procedural or object-oriented programming language, or in assembly or machine language if desired, with the language being a compiled or interpreted language. Data storage device 150 may be any form of non-volatile memory, including, for example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; and Compact Disc Read-Only Memory (CD-ROM).

System 100 may include one or more peripheral online storage devices 156 for storing estimating data. Peripheral online storage device 156 may use any storage media (including magnetic, optical or solid state storage media) or any type of storage device (including a drive, a microdrive, a compact disc (CD), a CD-recordable (CD-R), a CD-rewriteable (CD-RW), a flash memory, or a solid-state floppy disk card (SSFDC)).

System 100 also may include a communications card or device 160 (e.g., a modem and/or a network adapter) for exchanging data with a network 170 using a communications link 175 (e.g., a telephone line, a wireless network link, a wired network link, or a cable network). Other examples of system 100 may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

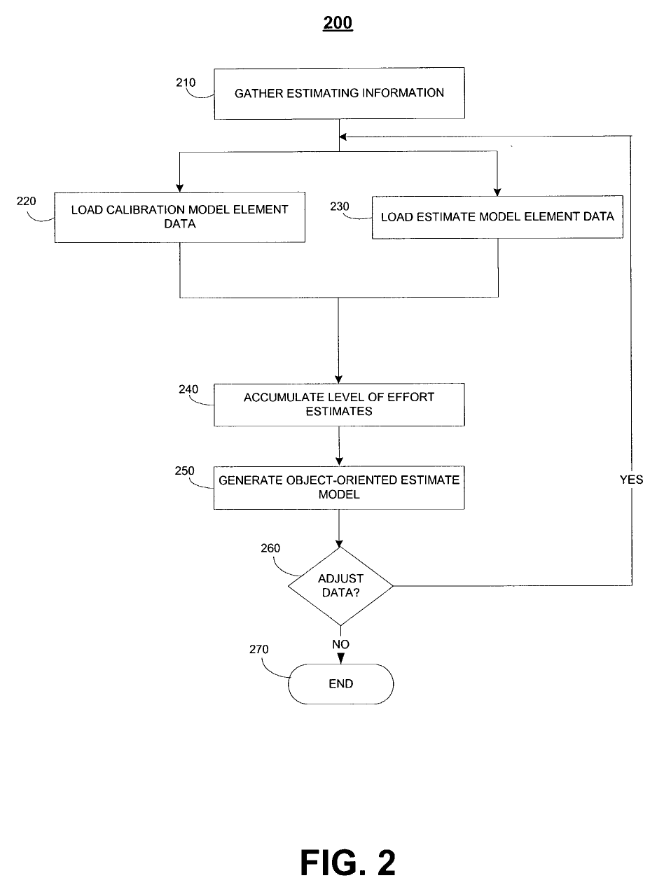

Referring to FIG. 2, an object-oriented system estimation process 200 may be performed throughout the planning, delivery, and installation of an object-oriented system and may make use of new information as that information becomes available. The process 200 is performed by a person working alone or as part of a group. The person or group may be referred to as an estimator. The process 200 controls a processor to generate an object-oriented estimate model.

The process 200 begins with gathering estimating information (step 210). Estimating information may include object-oriented system information (such as information about object classes, use cases, and visual interfaces) and other information (such as information about users, system infrastructure, security requirements, and required documentation) that may be useful in estimating the level of effort required to develop an object-oriented system. Estimating information may be provided by the developers or other people participating in the planning, delivery, installation or operation of the object-oriented system.

Typical information that may be available during the course of the planning, delivery, and installation of an system includes functional work products (such as functional requirements, functional specifications, and management reports), technical work products (such as design specifications, use case descriptions, and data models), existing system component information (such as hardware specifications, software specifications, and physical database descriptions), management information (such as management reports and contractual requirements for computer equipment or the system), and surveys that identify and/or quantify functions that the object-oriented system may perform.

The processor loads calibration model element data that associates an amount of human effort (which may be referred to as “a level of effort”) with a discrete aspect or activity associated with developing an object-oriented system (step 220). For example, a discrete aspect or activity for which the calibration model associates a level of effort estimate may be the time required to create an object class in a database, develop a method for an object class, develop a window in a user interface, define a set of business decision logic (which may be referred to as a business rule), generate a decision support output, facilitate a user-oriented design session, develop a data exchange interface with an external system, configure, manage, monitor, or provide security for a device (such as an enterprise server, a local server, or a desktop computer), or monitor an offline program. The calibration model element data is used to generate the level of effort estimate for an aspect or activity, or groups of aspects and activities, associated with developing an object-oriented system. The calibration model element data may be based on empirical data of effort required or a reasoned judgment of an estimator.

The processor loads estimate model element data based on the gathered estimating information (step 230). Estimate model element data may be loaded using a utility program that permits data relevant to object-oriented system estimation that has been gathered to be loaded into an object modeling tool, a metrics modeling tool, or a database. For example, an object modeling tool may organize model element data around an aspect of the object-oriented system, such as a business rule, an object class, a data exchange interface, a commercial-off-the-shelf program interface, a visual interface, or a subsystem. An object modeling tool also may organize object-oriented estimating information around object-oriented system development activities, such as requirements elicitation or design sessions with users, system integration testing, and technical architecture design.

The processor then accumulates the level of effort needed to plan, develop or acquire, deliver, and/or install an object-oriented system, or an aspect of an object-oriented system (step 240). The calibration model data is used with estimate model element data that identifies the number of particular aspects or activities that may need to be developed or performed to produce an estimate of the level of effort needed to perform the particular activity or to develop the particular aspect of the object-oriented system. For example, estimate model element data may include the number of methods to be developed for a particular object class, the number of windows to be developed for a particular visual interface, the number of physical interfaces to be developed with other computer systems, or the number of user sessions to be conducted for planning a particular aspect of the object-oriented system.

Some estimate model element data may be associated with other object-oriented system components, such as a subsystem, or with types of planning or development activities, such as infrastructure planning, application program development, or testing. The level of effort needed to perform particular activities or to develop particular aspects of the object-oriented system and other information associated with estimate model element data may be used to accumulate the level of effort needed to develop an aspect or perform activities at a higher level of abstraction.

For example, the level of effort needed to develop a particular method for a particular object class may be assumed to be equal to the level of effort needed to develop a method that is stored in the calibration model. The level of effort needed to develop all methods for a particular object class may be estimated by accumulating (or summing) the level of effort associated with each method associated with the particular object class. Alternatively, the level of effort needed to develop all methods for a particular object class may be estimated by determining the number of methods to be developed for the particular object class and multiplying the number of methods by the level of effort needed to develop a method that is stored in the calibration model.

The level of effort needed to develop all methods for all object classes for a particular subsystem then may be estimated by summing the level of effort needed for all of the methods for all object classes associated with the particular subsystem. The level of effort needed to develop all methods for all object classes of the object-oriented system may be estimated by summing the level of effort needed for all methods for all object classes for all subsystems.

The processor then generates an object-oriented estimate model (step 250). For example, an enterprise estimate model may be generated that identifies the total level of effort estimated to develop the object-oriented system. One or more additional object-oriented estimate models also may be generated, such as a business estimate model that describes the level of effort estimated to be needed to develop the business functions, business knowledge, or technical constraints for the object-oriented system; an information estimate model that describes the level of effort estimated to be needed to develop the procedures to create, retrieve, update, and delete information objects used in the object-oriented system; an application estimate model that describes the level of effort estimated to be needed to develop the application program including visual interfaces, program functions, and object data; a security model that describes the level of effort estimated to be needed to secure the object-oriented system (e.g., the level of effort estimated to be needed to define, develop, and install system, function or data access restrictions); an infrastructure model that describes the level of effort estimated to be needed to develop or acquire, test, and implement the infrastructure to support the object-oriented system (e.g., the level of effort estimate to perform capacity planning and to design, configure, and implement the compute devices (such as enterprise servers, local servers, and desktop computers), network devices, and physical interfaces to other systems); and a testing estimate model that describes the level of effort estimated to be needed to perform testing activities.

The processor provides a user interface that allows a user to adjust data (step 260), such as by loading calibration model element data (step 220) or estimate model element data (step 230). The user may adjust the calibration model element data based on the skills and experience of the development team, such as, for example, by increasing or decreasing the level of effort estimate associated with developing a method for an object class or a window in a user interface. The user may adjust the estimate model element data, such as, for example, by adding an object class and methods associated with the added object class, or a new visual interface and windows associated with the added visual interface, and by associating an object class or a visual interface with a particular subsystem. The user may adjust the data repeatedly (steps 220-250). When the user no longer wishes to adjust the data used or the estimate models generated, the processor ends the process (step 270).

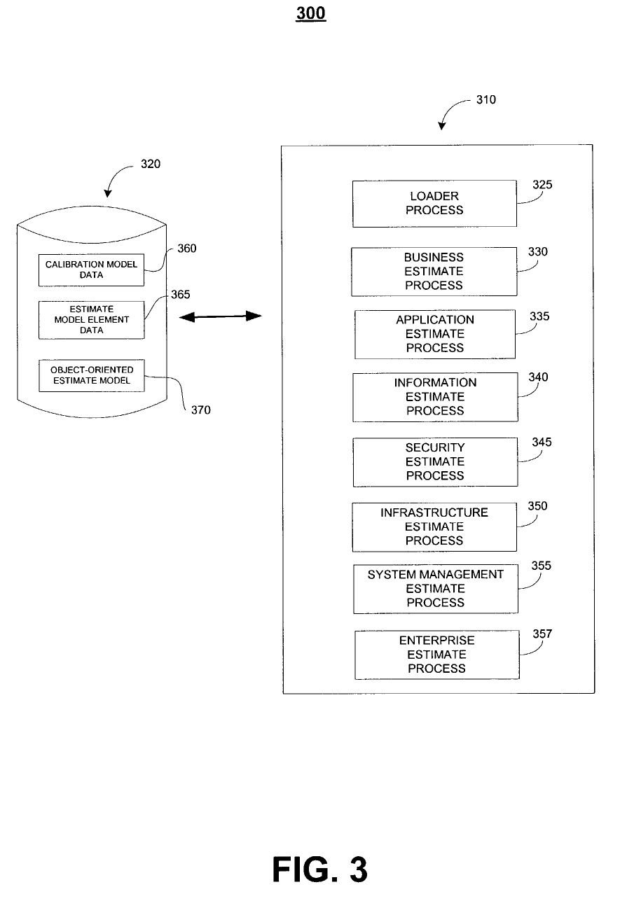

FIG. 3 depicts the components of a software architecture 300 for estimating the of level of effort needed to develop an object-oriented system. The software architecture has processing components 310 and data components 320. Processing components include a loader process 325, a business estimate process 330, an application estimate process 335, an information estimate process 340, a security estimate process 345, an infrastructure estimate process 350, a system management estimate process 355, and an enterprise estimate process 357.

The loader process 325 loads calibration model element data into a calibration model data storage component 360 and loads estimate model element data into an estimate model element data storage component 365.

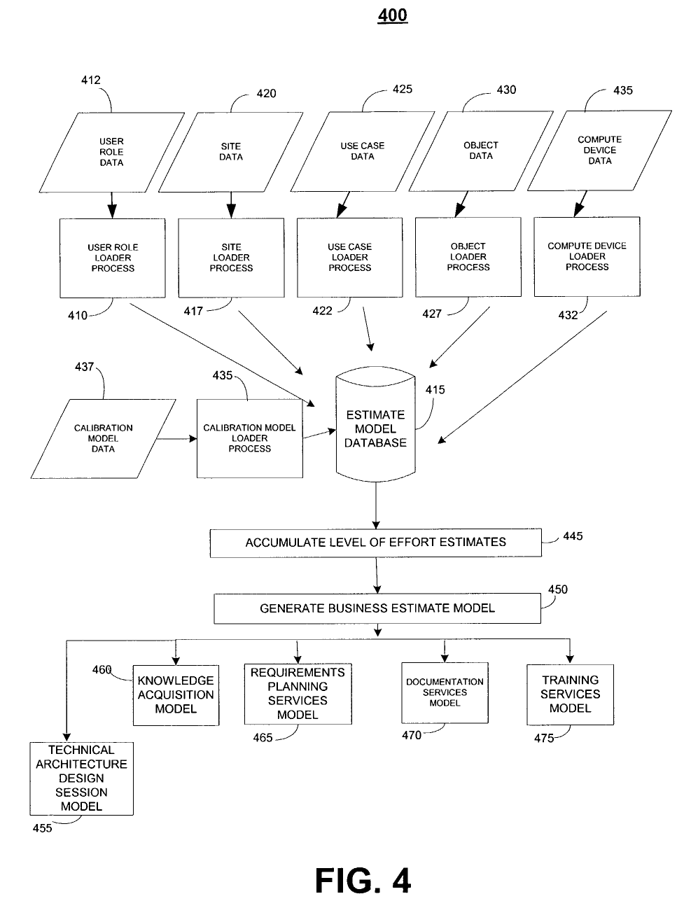

The business estimate process 330 uses calibration model data from the calibration model data storage component 360 and estimate model element data from the estimate model element data storage component 365 to generate a business estimate model, such as the business estimate model described below with respect to FIG. 4.

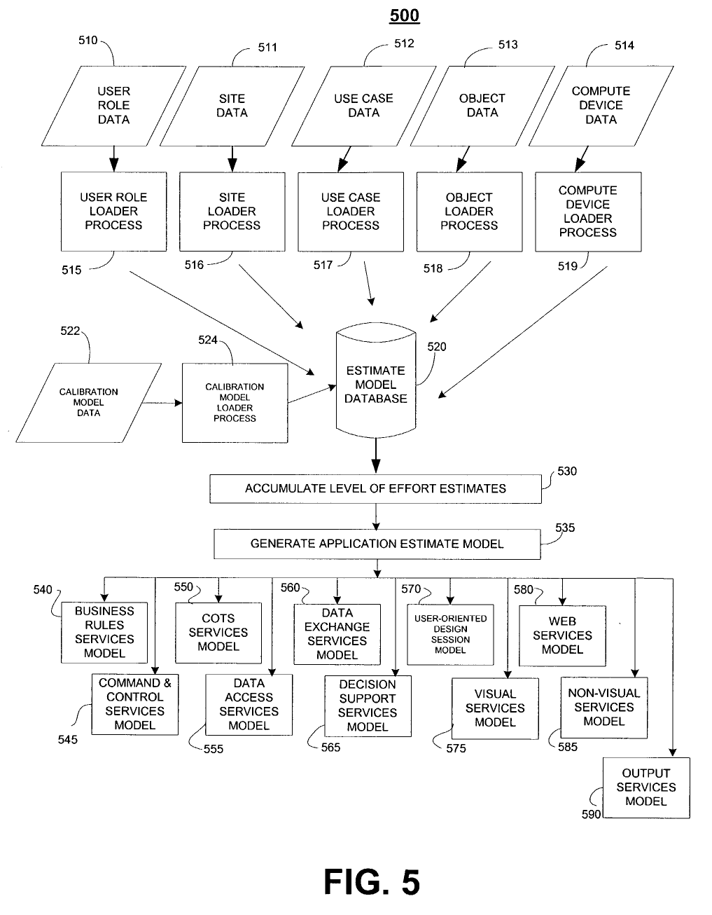

The application estimate process 335 uses calibration model data from the calibration model data storage component 360 and estimate model element data from the estimate model element data storage component 365 to generate an application estimate model, such as the application estimate model described below with respect to FIG. 5.

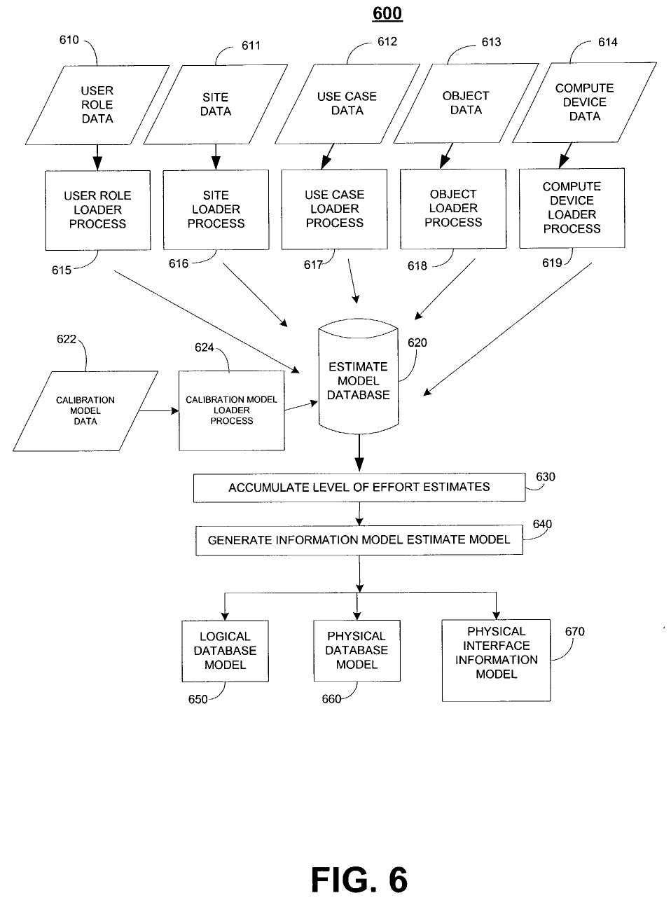

The information estimate process 340 uses calibration model data from the calibration model data storage component 360 and estimate model element data from the estimate model element data storage component 365 to generate an information estimate model, such as the information estimate model described below with respect to FIG. 6.

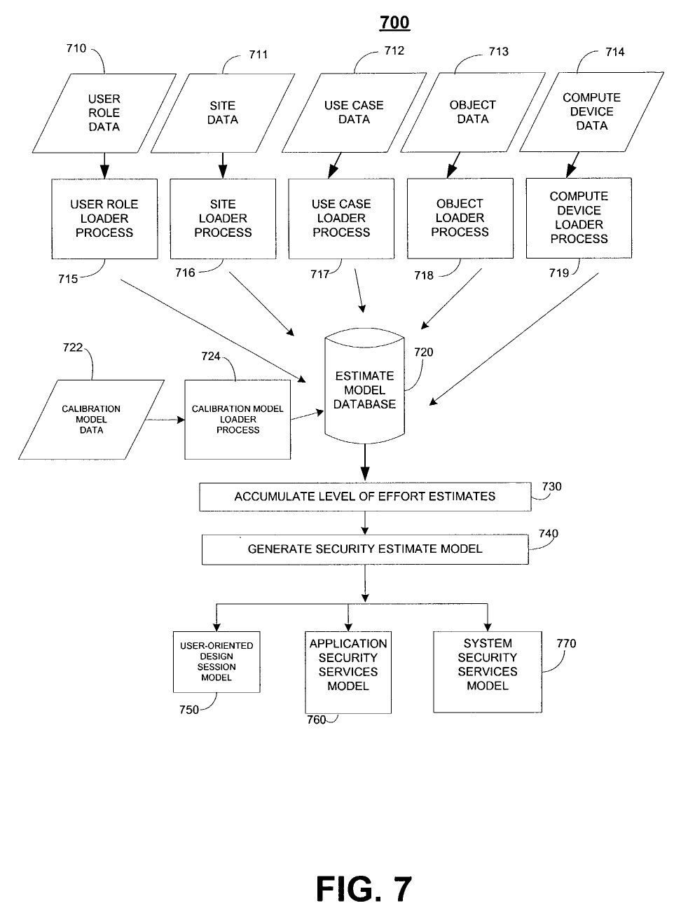

The security estimate process 345 uses calibration model data from the calibration model data storage component 360 and estimate model element data from the estimate model element data storage component 365 to generate a security estimate model, such as the security estimate model described below with respect to FIG. 7.

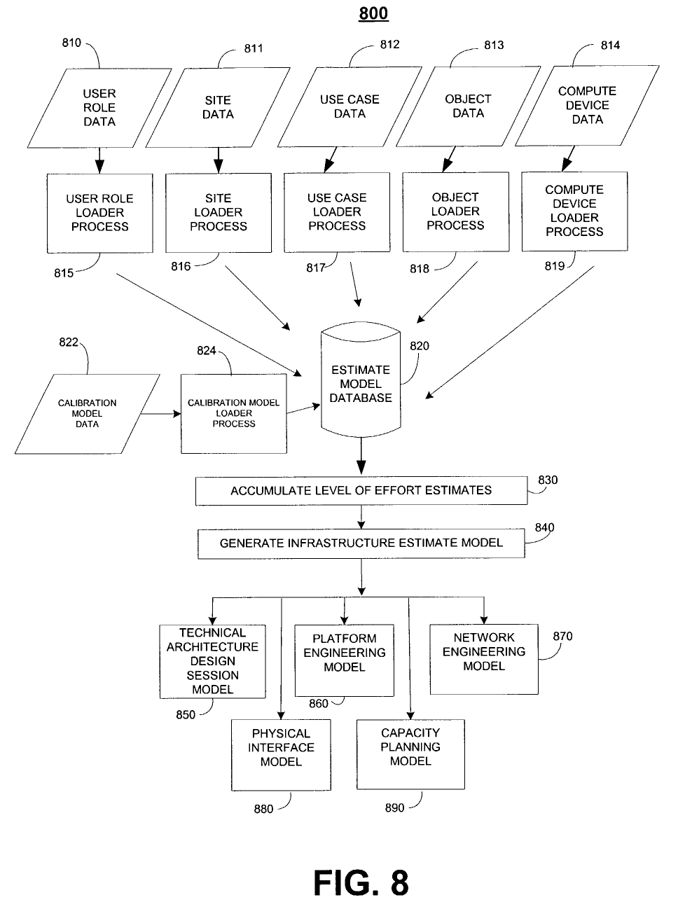

The infrastructure estimate process 350 uses calibration model data from the calibration model data storage component 360 and estimate model element data from the estimate model element data storage component 365 to generate an infrastructure estimate model, such as the infrastructure estimate model described below with respect to FIG. 8.

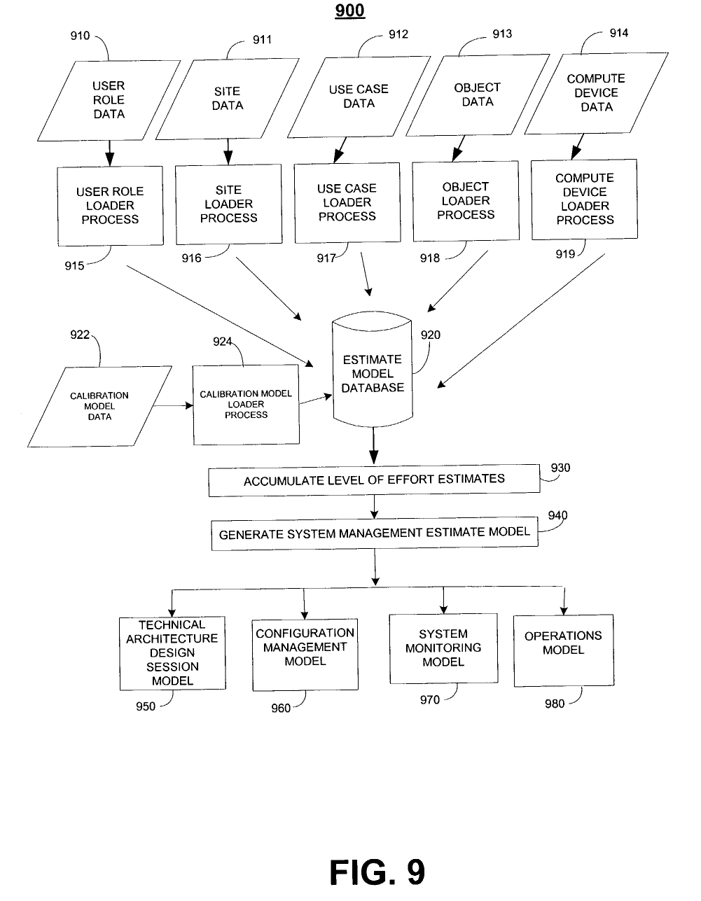

The system management estimate process 355 uses calibration model data from the calibration model data storage component 360 and estimate model element data from the estimate model element data storage component 365 to generate a system management estimate model, such as the system management estimate model described below with respect to FIG. 9.

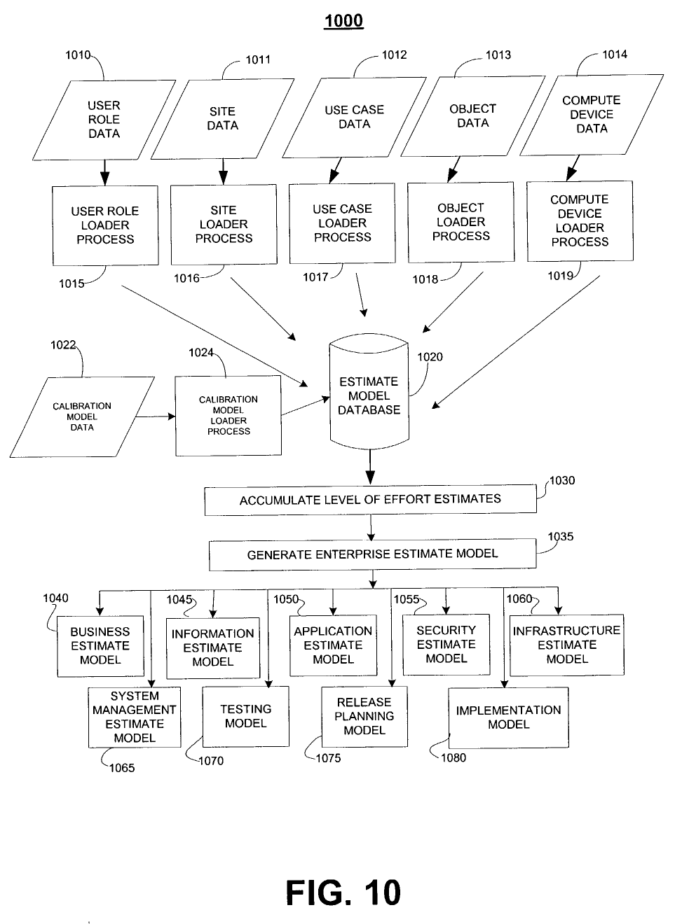

The enterprise estimate process 357 uses calibration model data from the calibration model data storage component 360 and estimate model element data from the estimate model element data storage component 365 to generate an enterprise estimate model, such as the enterprise estimate model described below with respect to FIG. 10.

The object-oriented estimate model or models generated may be stored in data component 370.

FIG. 4 illustrates a process 400 that is a more specific example of a process for estimating the level of effort required to develop an object-oriented system such as was described previously with respect to FIG. 2. The process 400 generates a business estimate model that describes the level of effort required to develop the business functions, business knowledge, or technical constraints for the object-oriented system.

The process 400 may use, for example, a version of Excel available from Microsoft Corporation to load one or more electronic spreadsheets for each type of model element data used in the business estimate model. The electronic spreadsheet may include a column for each type of model data element and a row for each record of model data to be loaded into the estimate model database. The estimate model database may be developed by using Rational Rose®, a visual modeling product available from Rational Software. The spreadsheet data may be loaded into the capacity planning model using Rational REI (Rose Extensibility Interface) that is also available from Rational Software.

A user role loader process (step 410) may be used to load into the estimate model database 415 a user role spreadsheet that has user role data 412. The user role spreadsheet includes a row for each user role and has columns that include a name and a description for each user role.

A site loader process (step 417) may be used to load into the estimate model database 415 a spreadsheet that has site data 420. The site spreadsheet includes a row for each organization site and has columns that include a site name, an address (street address, city, and state), a telephone number area code and prefix, and an indication as to whether the site uses dial-up connections for communications.

A use case loader process (step 422) may be used to load into the estimate model database 415 a spreadsheet that has use case data 425. The use case spreadsheet includes a row for each use case and has columns that include use case information. Use case information describes how the users may use the object-oriented system to perform one or more business processes or transactions. For example, a use case may describe how an invoice is processed or how a record for a new customer is entered into the object-oriented system.

The use case information includes a record for each use case (which may also be called an interaction). The record describes the interaction and information relating to capacity requirements for compute devices, such as, for example, enterprise servers, local servers, and desktop computers, and communication devices. The descriptive information for each interaction may include an interaction identification number and text description, the category of the interaction (such as invoice processing or entering new client information), the aspect of the system (often called a subsystem) to which the interaction relates, one or more user roles that are involved in performing the interaction, and the primary actor for the interaction.

An object loader process (step 427) may be used to load into the estimate model database 415 a spreadsheet that has object data 430. Object data may include object class, attribute, and operation (or method) information. The object spreadsheet includes a row for each object and has columns that include object class information for persistent object classes describing types of information physically stored, for example, in one or more object classes or for transient object classes describing data (such as results sets produced from database queries) that may be transmitted between communication devices and that are not stored permanently in the database. For each object class, the amount and type of storage needed is maintained. A persistent class may include information about, for example, customers, invoices, or reference data. For data stored in a relational database table, the persistent class model may include a record for each type of persistent class. Each record may include the persistent class name, the number of rows expected for the persistent class, the number and types of attributes for the object class, the total amount of storage required for the object class, and the type of storage (e.g., online disk, secondary disk storage, DVD, or tape). Some implementations may include the number of columns and the number of tables used for the object class.

A compute device loader process (step 432) may be used to load into the estimate model database 415 a spreadsheet that has compute device data 435. Information relating to resource requirements for compute device capacity and communication device capacity may include the type of compute devices that perform the interaction, a description of communication messages (such as the number and length of originating and responding communication messages) sent from one compute device to another during the interaction, an indication as to whether the communication is real time or initiated through a batch operation, an indication as to whether the response is synchronous or asynchronous, the average number of times per day that the interaction occurs, whether the interaction may create additional tasks, the number of rows impacted by each occurrence of the interaction, the number of columns impacted by each occurrence of the interaction, the response time requirement for the interaction, the memory required for the interaction, the source of the information used to describe the interaction, and the database profile (such as whether rows are inserted, modified, or deleted) of the interaction. The compute device spreadsheet includes a row for each compute device and has columns that include compute device information that is the same or similar to the compute device information described above.

A calibration model loader process (step 435) may be used to load into the estimate model database 415 a spreadsheet that has calibration model data 437. Calibration model data associates a level of effort estimate with a discrete aspect or activity associated with developing an object-oriented application, as described previously with respect to FIG. 2.

The processor accumulates level of effort estimates for the business estimate model using the calibration model data 437 and estimate model data stored in the estimate model database 415, such as user role data 412, site data 420, use case data 425, object data 430, and compute device data 435 (step 445). Accumulating level of effort estimates has been described previously with respect to step 240 in FIG. 2. The accumulated level of effort estimates may be stored in the estimate model database 415.

The processor then generates a business estimate model (step 450). The business estimate model organizes estimation data around aspects of the object-oriented system development. The estimation data describes the estimated level of effort to develop the business functions, business knowledge, or technical constraints for the object-oriented system, such as a technical architecture design session model 455, a knowledge acquisition model 460, a requirements planning services model 465, a documentation services model 470, and a training services model 475.

The technical architecture design session model 455 may include a level of effort estimate for designing the technical architecture, such as the infrastructure architecture that describes how the compute devices fit together or the software architecture that describes how the software components fit together. The technical architecture design session model 455 may include a level of effort estimate for each role (such as chief architect, network architect, software engineer, facilitator, recorder or scribe, or user) involved in each task for each planned technical architecture design task. The technical architecture design session model 455 may include level of effort estimates for planning sessions. Estimates for a particular role, a particular planning session, or all requirements planning sessions may be accumulated in step 445 and included in the technical architecture design session model 455.

The knowledge acquisition service model 460 may include a level of effort estimate for eliciting from the users the business rules required to support business operations (such as financial eligibility determination for a financial system). The knowledge acquisition model 460 may include information about each business rule, such as the subsystem to which the business rule relates, the business rule engine in which the business rule resides, a level of effort estimate associated with the business rule, and a unique identifier for the business rule. Knowledge acquisition estimates may be accumulated, for example, for a particular business rule engine, a particular subsystem, or for all business rules.

The requirements planning services model 465 may include, for example, a level of effort estimate for an activity associated with defining the object-oriented system requirements, such as conducting a requirements elicitation session with a group of users. The requirements planning services model 465 may include a level of effort estimate for each role (such as facilitator, recorder or scribe, technical analyst, business analyst, or user) involved in each task for each requirements elicitation session planned. Estimates for a particular role, a particular user-oriented design session, or all requirements planning sessions may be accumulated and included in the requirements planning services model 465.

The documentation services model 470 may include the activities associated with developing and producing documentation, such as technical documentation, user documentation, print documentation, and online documentation, for aspects of the object-oriented system that support business operations. The documentation services model 470 may include a level of effort estimate for each role (such as business analyst, technical analyst, technical writer, or editor) involved in developing each documentation product, such as a user guide, technical manual, data dictionary, and online help content. Some implementations may allow a level of estimate that is not associated with a particular role to be associated with a particular documentation product. Estimates for a particular role, a particular documentation product, or all documentation activities may be accumulated and included in the documentation services model 470.

The training services model 475 may include, for example, the activities associated with developing and delivering training for the object-oriented system. The training services model may include a level of effort estimate for each role (such as business analyst, technical analyst, instructional designer, technical writer, or editor) involved in producing each training product produced, such as an instructor guide, participant guide, and online training content. The training services model 475 for the business estimate model also may include a level of effort estimate for each role involved in delivering a training session (such as an instructor or technical support specialist). Some implementations may allow a level of estimate that is not associated with a particular role to be associated with a particular training product or session. Level of effort estimated to be needed for a particular role, a particular training product, a particular training session, or all training activities may be accumulated and included in the training services model 475.

The estimate models produced may be adjusted as described above with respect to FIG. 2.

Some implementations may print or otherwise output the calibration model data 437 or some or all of the model data element data 412, 420, 425, 430, and 435 using the data source that was loaded into the estimate model database 415 (e.g., from a spreadsheet) or using the estimate model database 415 itself.

FIG. 5 illustrates a process 500 for generating an application estimate model that describes the level of effort estimated to be needed to develop the system, including, for example, to develop visual interfaces, business rules, and interfaces to other systems.

As described above with respect to FIG. 4, a process 500 controls a processor to load into an estimate model database 520 estimate model data 510-514 using loader processes 515-519. The processor uses calibration model loader process 524 to load calibration model data 522 into the estimate model database 520, as described previously with respect to FIG. 4.

The processor accumulates level of effort needed for the application estimate model using the calibration model data 522 and estimate model data stored in the estimate model database 520, such as user role data 510, site data 511, use case data 512, object data 513, and compute device data 514 (step 530). Accumulating level of effort estimates has been described previously with respect to step 240 in FIG. 2. The accumulated level of effort estimates may be stored in the estimate model database 520.

The processor then generates an application estimate model (step 535). The application estimate model organizes estimation data around aspects of the object-oriented system associated with programming the application program, such as a business rules services model 540, a command and control services model 545, a commercial-off-the-shelf (COTS) services model 550, a data access services model 555, a data exchange services model 560, a decision support services model 565, a user-oriented design session model 570, a visual services model 575, a web services model 580, and a non-visual services model 585.

The business rules services model 540 may include a level of effort estimated to be needed to develop the decision logic needed for the object-oriented system to support the required functions (such as financial eligibility determination for a financial application program). The business rules services model 540 may include information about each business rule, such as the subsystem to which the business rule relates, the business rule engine to which the business rule applies, the level of effort needed to develop the business rule, and a unique identifier for the business rule. The business rules services model 540 may include a level of effort needed, for example, for a particular business rule engine, a particular subsystem, or for all business rules.

The command and control services model 545 may include a level of effort estimated to be needed to develop software to generate messages, such as a message to remind a user to perform a particular function. The command and control services model 545 may include information about each message to be generated, such as the subsystem to which the message applies, the level of effort needed to develop the message, and a unique identifier for the message. The command and control services model 545 may include the level of effort needed, for example, to develop all messages for a particular subsystem or all subsystems.

The COTS services model 550 may include a level of effort estimated to be needed to develop the interfaces to commercial products, such as Microsoft® Office by Microsoft Corporation. The COTS services model 550 may include information about each method that accesses a particular application programming interface (API) for a COTS product, such as a unique identifier for the method accessing a particular API, the level of effort needed to develop the method, and a subsystem to which the method applies. The COTS services model 550 may include the level of effort needed, for example, for a particular subsystem, all subsystems, or all methods that interface with a particular COTS product.

The data access services model 555 may include a level of effort estimated to be needed to develop the interfaces required to obtain information from data base management systems, file systems, and other storage systems that are part of the object-oriented system. The data access services model 555 may include information about each data access needed, such as the level of effort associated with the access, the applicable subsystem, and a unique identifier for each type of data access operation (e.g., create, retrieve, modify, or delete) for each type of group of attributes (e.g., address information or contact name information) for each object class (e.g., client or employee). The data access services model 555 may include a level of effort needed to develop, for example, a particular object class, a type of data access operation, a subsystem, or all data access operations.

The data exchange services model 560 may include a level of effort estimated to be needed to develop the software to support the exchange of data with other computer systems, such as an external computer system that is controlled by another legal entity, and may transform, send, or receive data. The data exchange services model 560 may include may include information about each data exchange developed, such as the level of effort needed to develop the data exchange, the applicable subsystem, and a unique identifier for each type of event (such as send data, receive data, or process received data) for each type of data exchange (such as daily or monthly) for each external system with which an object class exchanges data. The data exchange services model 560 may include the level of effort needed to develop, for example, a particular object class, a particular external system, a type of data exchange, a type of event, a subsystem, or all data exchange operations.

The decision support services model 565 may include a level of effort estimated to be needed to develop decision support software to obtain information from internal storage and format the information for output, such as printing. The decision support services model 565 may include information about each decision support function or output, such as the level of effort needed to develop the decision support function or output, the applicable subsystem, and the unique identifier for each function or output (such as generating a particular report). The decision support services model 565 may include a level of effort needed to develop, for example, all decision support functions or outputs for a particular subsystem, or all decision support functions or outputs for all subsystems.

The user-oriented design session model 570 may include a level of effort estimated to be needed to plan, conduct, and summarize one or more meetings (which also may be referred to as sessions) associated with object-oriented system development activities, such as requirements elicitation or design sessions with users. The user-oriented design session model 570 may include the level of effort needed for each role (such as facilitator, recorder or scribe, technical analyst, business analyst, or end user) involved in each task for each session. Some implementations also may associate a level of effort estimate for one or more tasks that is not associated with a particular role. The user-oriented design session model 570 may include other information for each session, such as a session topic and associated tasks (e.g., the development of use cases for each object class or the development of a storyboard for each visual interface), an applicable subsystem, and a unique identifier. The user-oriented design session model 570 may include level of effort estimates, for example, for a particular session, a particular subsystem, or all user sessions.

The visual services model 575 may include a level of effort estimated to be needed to develop the visual interface for the object-oriented system. The visual services model 575 may include a level of effort estimate for each visual event associated with each window in the visual interface for the object-oriented system. The visual services model 575 may include other information for each visual event, such as an applicable subsystem and a unique identifier. The visual services model 575 may include a level of effort, for example, for a particular visual event, all visual events for a particular window, all windows in a particular a subsystem, or all windows.

A web services model 580 may include a level of effort estimated to be needed to develop one or more interfaces for the World Wide Web or an intranet using HTML (Hypertext Mark-up Language) documents or other hypertext document retrieval techniques (which may be referred to as a web page). A web services model 580 may include an level of effort needed to develop each web page for the object-oriented system. A web services model 580 may include other information for each web page, such as an applicable subsystem and a unique identifier. A web services model 580 may include a level of effort, for example, for all web pages of a particular subsystem or all web pages of the entire system.

The non-visual services model 585 may include the level of effort estimated to be needed to develop other processing required in the object-oriented system. The non-visual services model 585 may include the level of effort needed, an applicable subsystem, and a unique identifier for each non-visual event. The non-visual services model 585 also may include the level of effort needed to develop non-visual events, for example, for a particular subsystem or all non-visual events for the entire system.

The output services model 590 may include the level of effort estimated to be needed to develop reports or other documents that are printed by the object-oriented system. The output services model 590 may include the level of effort needed, an applicable subsystem, and a unique identifier for each printed report or other document. The output services model 590 also may include the level of effort needed to develop the printed reports or other documents, for example, for a particular subsystem or all printed reports and other documents for the entire system.

The estimate models produced may be adjusted as described above with respect to FIG. 2.

Some implementations may print or otherwise output the calibration model data 522 or some or all of the model data element data 510-514 using the data source that was loaded into the estimate model database 520 (e.g., from a spreadsheet) or using the estimate model database 520 itself.

FIG. 6 illustrates a process 600 for estimating the level of effort estimate required for development activities involving information modeling, such as developing a logical data model, a physical data model, or a physical interface model.

As described above with respect to FIG. 4, process 600 controls a processor to use loader processes 615-619 to load estimate model data 610-614 into an estimate model database 620. The processor also loads calibration model data 622 using calibration model loader process 624, as previously described with respect to FIG. 4.

The processor accumulates the level of effort needed for the information model estimate model using the calibration model data 622 and estimate model data stored in the estimate model database 620, such as user role data 610, site data 611, use case data 612, object data 613, and compute device data 614 (step 630). Accumulating level of effort estimates has been described previously with respect to step 240 in FIG. 2. The accumulated level of effort estimates may be stored in the estimate model database 620.

The processor then generates an information model estimate model (step 640). The information model estimate model may include the level of effort estimated to be needed to develop information models and databases, such as a logical database model 650, a physical database model 660, and an interface information model 670.

The logical database model 650 may include the level of effort estimated to be needed to develop modeling information for each logical data entity, such as an employee, a customer, or a business supplier, or for each component of an entity, such as the work address for an employee or contact information for a business supplier. The logical database model 650 may include the level of effort estimated to be needed to develop each logical database element (e.g., a database table) or activity (e.g., a modeling session). The logical database model 650 may include other information for each logical database element, such as an applicable subsystem and a unique identifier. The logical database model 650 may include a level of effort estimated to be needed to develop, for example, the logical database elements or activities for a particular subsystem or for all subsystems.

The physical data model 660 may include the level of effort estimated to be needed to develop each physical data entity (such as a database table, a database index, or a data set) or component of a physical data entity (such as a group of related attributes) and an associated subsystem for each physical data entity or component. The physical data model 660 also may include the level of effort estimated to be needed to develop, for example, all physical data entities for a particular subsystem or all subsystems.

The physical interface information model 670 may include the level of effort estimated to be needed to model the transformation and exchange of information in each physical interface with another computer system. The physical interface information model 670 may include other information for each physical interface, such as a unique identifier and an associated subsystem. The physical interface information model 670 may include the level of effort estimated to be needed to develop, for example, a subsystem or all data exchange operations.

The estimate models produced may be adjusted as described above with respect to FIG.2.

Some implementations may print or otherwise output the calibration model data 622 or some or all of the model data element data 610-614 using the data source that was loaded into the estimate model database 620 (e.g., from a spreadsheet) or using the estimate model database 620 itself.

FIG. 7 describes a process 700 for estimating the level of effort to be needed to develop security for the object-oriented system. As described above with respect to FIG. 4, a process 700 controls a processor to load into the estimate model database 720 estimate model data 710-714 using loader processes 715-719. The processor also loads into the estimate model database 720 calibration model data 722 using calibration model loader process 724, as described previously with respect to FIG. 4.

The processor accumulates level of effort needed for the security estimate model using the calibration model data 722 and estimate model data stored in the estimate model database 720, such as user role data 710, site data 711, use case data 712, object data 713, and compute device data 714 (step 730). Accumulating level of effort estimates has been described previously with respect to step 240 in FIG. 2. The accumulated level of effort estimates may be stored in the estimate model database 720.

The processor then generates a security estimate model (step 740). The security estimate model may include a level of effort estimated to be needed to secure the object-oriented system (e.g., the level of effort needed to define, develop, and install system, function, or data access restrictions). The security estimate model may include a user-oriented design session model 750, an application security services model 760, and a system security services model 770.

The user-oriented design session model 750 is similar to the user-oriented design session model 570 described above with respect to FIG. 5. The user-oriented design session model 750 may include the level of effort estimated to be needed to plan, conduct and summarize one or more sessions or meetings to define the security requirements for the object-oriented system, such as requirements elicitation, design sessions, or technical architecture design sessions with users. The user-oriented design session services model 750 may include the level of effort needed for each role (such as facilitator, recorder or scribe, chief architect, network architect, security architect, software engineer, or end user) involved in each task for each session. Some implementations also may include a level of effort needed for one or more tasks that are not associated with a particular role. The user-oriented design session model 750 may include other information for each session, such as a session topic and associated tasks, an applicable subsystem, and a unique identifier. The user-oriented design session services model 750 may include a level of effort estimated to be needed, for example, for a particular session, a particular subsystem, or all user sessions related to security.

The application security services model 760 may include the level of effort estimated to be needed to develop security measures to protect the business functions and information of the object-oriented application. The application security services model 760 may include a level of effort needed to develop each application security measure to be implemented and all application security measures. Some implementations may associate one or more application security measures with a particular subsystem.

The system security services model 770 may include the level of effort estimated to be needed to develop security measures to protect the system operating the object-oriented system, such as restricting physical access to some devices (e.g., server components and network devices), restricting user privileges to read from and/or write to the database used to store the data of the object-oriented system, and auditing operating system functions. The system security services model 770 may include a level of effort needed to define a security policy for information, sites, and devices and to configure devices appropriately. The system security services model 770 also may include a level of effort needed to develop each system security measure and all system security measures. Some implementations may associate one or more system security measures with a particular subsystem, device, or site.

The estimate models generated may be adjusted as described above with respect to FIG. 2.

Some implementations may print or otherwise output the calibration model data 722 or some or all of the model data element data 710-714 using the data source that was loaded into the estimate model database 720 (e.g., from a spreadsheet) or using the estimate model database 720 itself.

FIG. 8 describes a process 800 for estimating the level of effort needed to develop and/or acquire, test, and implement the infrastructure to support the object-oriented system (e.g., the level of effort estimate to design, configure, and implement the compute devices (such as enterprise servers, local servers, and desktop computers), network devices, and physical interfaces to other systems).

As described above with respect to FIG. 4, a process 800 controls a processor to use loader processes 815-819 to load estimate model data 810-814 into an estimate model database 820. The processor also loads into estimate model database 820 the calibration model data 822 using the calibration model loader process 824, as described previously with respect to FIG. 4.

The processor accumulates level of effort needed for the infrastructure estimate model using the calibration model data 822 and estimate model data stored in the estimate model database 820, such as user role data 810, site data 811, use case data 812, object data 813, and compute device data 814 (step 830). Accumulating level of effort estimates has been described previously with respect to step 240 in FIG. 2. The accumulated level of effort estimates may be stored in the estimate model database 820.

The processor then generates an infrastructure estimate model (step 840). The infrastructure estimate model may include a technical architecture design session model 850, a platform engineering model 860, a network engineering model 870, a physical interface model 880, and a capacity planning model 890. The technical architecture design session model 850 has been described above with respect to item 455 in FIG. 4.

The platform engineering model 860 may include the level of effort estimated to be needed to develop and/or acquire, configure, test, and implement the compute devices (e.g., desktops, workstations, laptops, and servers) needed by the object-oriented system. The platform engineering model 860 may include the level of effort needed to engineer each compute device, all compute devices associated with a particular site, or all compute devices in the entire system. Some implementations may include the level of effort needed to engineer a particular type of compute device for a particular site, such as all laptop computers or all desktop computers associated with a particular site, or all compute devices of a particular type in the entire system, such as all laptop computers or all desktop computers.

The network engineering model 870 may include the level of effort estimated to be needed to develop and/or acquire, configure, test, and implement the network devices needed by the object-oriented system. The network engineering model 870 may include the level of effort needed to design each network device, all network devices associated with a particular site, or all network devices in the entire system. The network engineering model 870 also may include the level of effort needed to implement each network device, all network devices associated with a particular site, or all network devices in the entire system.

The physical interface model 880 may include the level of effort estimated to be needed to develop physical interfaces to systems associated with the object-oriented system. The physical interface model 880 may include the level of effort needed to develop each physical interface or all physical interfaces.

The capacity planning model 890 may include the level of effort needed to perform capacity planning, such as estimating the database capacity, the number and type of compute devices, and the number and type of network devices required.

The estimate models generated may be adjusted as described above with respect to FIG. 2.

Some implementations may print or otherwise output the calibration model data 822 or some or all of the model data element data 810-814 using the data source that was loaded into the estimate model database 820 (e.g., from a spreadsheet) or using the estimate model database 820 itself.

FIG. 9 describes a process 900 for estimating the level of effort required for developing or acquiring system management functions for the object-oriented application system. As described above with respect to FIG. 4, a process 900 controls a processor to use loader processes 915-919 to load estimate model data 910-914 into an estimate model database 920. The processor also loads into estimate model database 920 the calibration model data 922 using the calibration model loader process, as described previously with respect to FIG. 4.

The processor accumulates the level of effort needed for the system management estimate model using the calibration model data 922 and estimate model data stored in the estimate model database 920, such as user role data 910, site data 911, use case data 912, object data 913, and compute device data 914 (step 930). Accumulating level of effort estimates has been described previously with respect to step 240 in FIG. 2. The accumulated level of effort estimates may be stored in the estimate model database 920.

The processor then generates a system management estimate model (step 940). The system management estimate model may include a technical architecture design session model 950, a configuration management model 960, a system monitoring model 970, and an operations model 980.

The technical architecture design session model 950 has been described above with respect to item 455 in FIG. 4. The configuration management model 960 may include the level of effort estimated to be needed to acquire and/or develop, configure, test, and install a configuration management system and procedures for the object-oriented system. The configuration management model 960 also may include the level of effort estimated to be needed to repair, replace, move, add, or modify a device, such as an enterprise server, a local server, a desktop computer, or a networking device, for all devices associated with a particular site, or all devices in the entire system.

The system monitoring model 970 may include the level of effort estimated to be needed to develop, test, and install system-wide monitoring procedures. The system monitoring model 970 also may include the level of effort needed to monitor a device, such as an enterprise server, a local server, a desktop computer, or a networking device, all devices associated with a particular site, or all devices in the entire system.

The operations model 980 may include the level of effort estimated to be needed to operate the object-oriented system. The operations model 980 also may include the level of effort needed to operate an offline program, all offline programs associated with a particular subsystem, or all offline programs in the entire system.

The estimate models generated may be adjusted as described above with respect to FIG. 2.

Some implementations may print or otherwise output the calibration model data 922 or some or all of the model data element data 910-914 using the data source that was loaded into the estimate model database 920 (e.g., from a spreadsheet) or using the estimate model database 920 itself.

FIG. 10 describes a process 1000 for estimating the level of effort required for developing object-oriented application system for an enterprise.

As described above with respect to FIG. 4, a process 1000 controls a processor to use loader processes 1015-1019 to load estimate model data 1010-1014 into an estimate model database 1020. The processor also loads into estimate model database 1020 the calibration model data 1022 using the calibration model loader process 1024, as described previously with respect to FIG. 4.

The processor accumulates level of effort needed for the system management estimate model stored in the estimate model database 1020 using the calibration model data 1022 and estimate model data, such as user role data 1010, site data 1011, use case data 1012, object data 1013, and compute device data 1014 (step 1030). Accumulating level of effort estimated to be needed has been described previously with respect to step 240 in FIG. 2. The accumulated level of effort estimates may be stored in the estimate model database 1020.

The processor then generates an enterprise estimate model (step 1035). The enterprise estimate model may include a business estimate model 1040 (such as the business estimate model described above with respect to FIG. 4), an information estimate model 1045 (such as the information estimate model described above with respect to FIG. 6), an application estimate model 1050 (such as the application estimate model described above with respect to FIG. 5), a security estimate model 1055 (such as the security estimate model described above with respect to FIG. 7), an infrastructure estimate model 1060 (such as the infrastructure estimate model described above with respect to FIG. 8), a system management estimate model 1065 (such as the system management estimate model described above with respect to FIG. 9), a testing model 1070, a release planning model 1075, and an implementation model 1080.

The testing model 1070 may include the level of effort estimated needed to perform various types of tests, such as system testing, system integration testing, and user acceptance testing (which may also be referred to as validation testing), or other types of quality assurance or verification and validation activities. The testing model 1070 may include the level of effort needed for each subsystem for each type of testing, a particular a subsystem, a particular type of test, or all testing activities. Some implementations may associate the level of effort needed to perform testing activities at a lower level of abstraction, for example, the level of effort needed to test a user interface, a physical interface, a data object, or an access to a data object required.

The release planning model 1075 may include the level of effort needed to develop each planned release of an object-oriented application system. For example, the level of effort needed that is used in various estimate models may also be associated with a particular release such that the level of effort needed for a particular release may be generated.

The implementation model 1080 may include the level of effort needed to install the object-oriented system in an organization. The implementation model may include the level of effort needed to install software for the object-oriented system, and implement the infrastructure to support the object-oriented system.

The estimate models generated may be adjusted as described above with respect to FIG. 2.

Some implementations may print or otherwise output the calibration model data 1022 or some or all of the model data element data 1010-1014 using the data source that was loaded into the estimate model database 1020 (e.g., from a spreadsheet) or using the estimate model database 1020 itself.

The estimate models, loader processes, and spreadsheets described with respect to FIGS. 4-10 are illustrative. Some implementations may not use all the estimate models described. Some implementations may use other spreadsheets or other methods of loading and manipulating estimate model data. For example, some implementations may use XML (Extensible Mark-up Language) to load data into an estimate model or database.

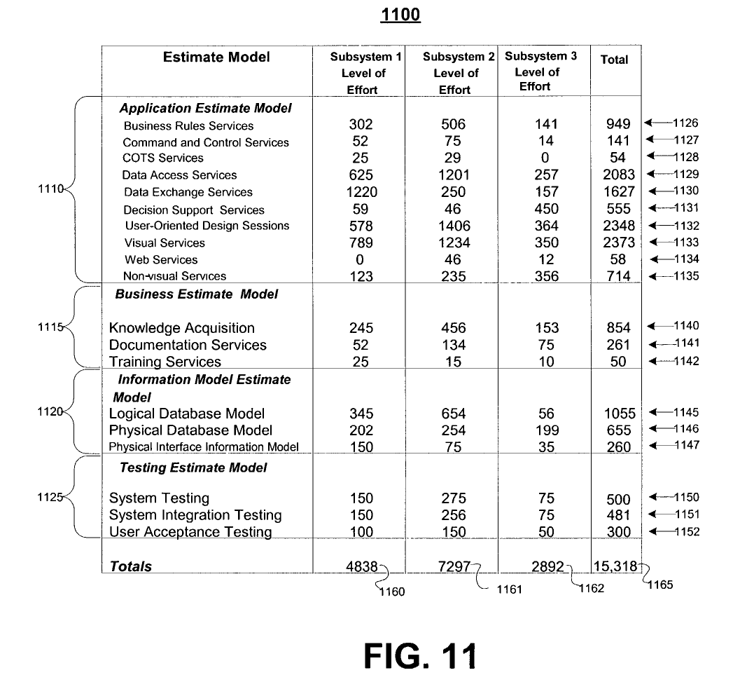

FIG. 11 shows a result of an object-oriented application estimating process. An object-oriented application estimate model 1100 was produced by accumulating the level of effort needed using an application estimate model 1110, a business estimate model 1115, an information model estimate model 1120, and a testing estimate model 1125.

Application estimate model 1110 includes a total and sub-totals for three subsystems of the accumulated level of effort needed for business rules services 1126, command and control services 1127, COTS services 1128, data access services 1129, data exchange services 1130, decision support services 1131, user-oriented design sessions 1132, visual services 1133, web services 1134, and non-visual services 1135.

Business analyst estimate model 1115 includes a total and sub-totals for three subsystems of the accumulated level of effort needed for knowledge acquisition 1140, documentation services 1141, and training service 1142.

Information estimate model 1120 includes a total and sub-totals for three subsystems of the accumulated level of effort needed for a logical database model 1145, a physical database model 1146, and a physical interface information model 1147.

Testing estimate model 1125 includes a total and sub-totals for three subsystems of the accumulated level of effort needed for system testing 1150, system integration testing 1151, and user acceptance testing 1152.

Object-oriented estimate model 1100 includes a total for each of the subsystems 1160-1162 and an overall total for all three subsystems 1165.

The benefits of object-oriented system estimation may be equally applicable to a variety of contexts, such as object-oriented system development for a commercial off-the-shelf product, object-oriented system development and implementation for a particular organization (which may be referred to as custom development), modifying a commercial off-the-shelf product for implementation for a particular organization (which may be referred to as customizing a product), object-oriented system development for research, and other types of object-oriented system development.

Implementations may include a method or process, an apparatus or system, or computer software on a computer medium. It will be understood that various modifications may be made without departing from the spirit and scope of the following claims. For example, advantageous results still could be achieved if steps of the disclosed techniques were performed in a different order and/or if components in the disclosed systems were combined in a different manner and/or replaced or supplemented by other components.

Other implementations are within the scope of the following claims.

What is claimed is:

1. A computer-implemented method for estimating a level of effort required for developing an object-oriented system, the method comprising:
at one or more computer systems, receiving estimating information;
at one or more of the one or more computer systems, receiving one or more level of effort estimates, with each level of effort estimate being associated with an aspect or activity associated with developing an object-oriented system;
accumulating the one or more level of effort estimates received using at least one of the one or more computer systems;
generating one or more estimate models using the accumulated level of effort estimates and at least one of the one or more computer systems; and
repeating the accumulating of the one or more level of effort estimates and the generating of the one or more estimate models as more estimating information is provided.

2. The method of claim 1 wherein generating one or more estimate models comprises generating one or more of an application estimate model, a business estimate model, an information model estimate model, a security estimate model, an infrastructure estimate model, a system management estimate model, and an enterprise estimate model.

3. The method of claim 2 wherein the application estimate model comprises one or more of a business rule services model, a visual services model, a data exchange services model, a user-oriented design session model, a commercial-off-the-shelf interface services model, a World Wide Web services model, a decision support services model, and an output services model.

4. The method of claim 1 wherein at least one of the one or more level of effort estimates comprises a level of effort estimate associated with developing an object class.

5. The method of claim 4 wherein at least one of the one or more level of effort estimates associated with developing an object class comprises a level of effort estimate associated with developing a method associated with an object class.

6. The method of claim 1 wherein at least one of the one or more level of effort estimates comprises a level of effort estimate associated with developing a visual interface.

7. The method of claim 6 wherein at least one of the one or more level of effort estimates comprises a level of effort estimate associated with developing a window for a visual interface.

8. The method of claim 1 wherein at least one of the one or more level of effort estimates comprises a level of effort estimate associated with developing an interface to a computer system.

9. The method of claim 1 wherein at least one of the one or more level of effort estimates comprises a level of effort estimate associated with conducting a user-oriented design session.

10. The method of claim 1 wherein at least one of the one or more level of effort estimates comprises a level of effort estimate associated with developing a component of an information model.

11. The method of claim 1 wherein at least one of the one or more level of effort estimates comprises a level of effort estimate associated with configuring a device.

12. The method of claim 1 wherein at least one of the one or more level of effort estimates comprises a level of effort estimate associated with engineering one or more network devices for a site.

13. The method of claim 1 wherein at least one of the one or more level of effort estimates comprises a level of effort estimate associated with managing or monitoring a device.

14. The method of claim 1 wherein at least one of the one or more level of effort estimates comprises a level of effort estimate associated with operating an offline program.

15. The method of claim 1 wherein at least one of the one or more level of effort estimates comprises a level of effort estimate associated with performing configuration management for a device.

16. The method of claim 15 wherein at least one of the one or more level of effort estimates comprises a level of effort estimate associated with one or more of repairing a device, replacing a device, moving a device, adding a device, and modifying the configuration of a device.

17. The method of claim 1 wherein at least one of the one or more level of effort estimates comprises a level of effort estimate associated with providing security for a collection of information, a site or a device.

18. The method of claim 1 wherein at least one of the one or more level of effort estimates comprises a level of effort estimate associated with defining a security policy.

19. The method of claim 1 wherein at least one of the one or more level of effort estimates comprises a level of effort estimate associated with configuring a device to provide security for the device.

20. A computer-readable medium or propagated signal having embodied thereon a computer program configured to estimate a level of effort required to develop an object-oriented system, the medium comprising one or more code segments configured to:
receive estimating information at one or more computer systems;
receive one or more level of effort estimates at one or more of the one or more computer systems, with each level of effort estimate being associated with an aspect or activity associated with developing an object-oriented system;
accumulate the one or more level of effort estimates received using at least one of the one or more computer systems;
generate one or more estimate models using the accumulated level of effort estimates and at least one of the one or more computer systems; and
repeat the accumulating of the one or more level of effort estimates and the generating of the one or more estimate models as more estimating information is provided.

21. The medium of claim 20 wherein the one or more code segments configured to generate one or more estimate models comprises one or more code segments configured to generate one or more of an application estimate model, a business estimate model, an information model estimate model, a security estimate model, an infrastructure estimate model, a system management estimate model, and an enterprise estimate model.

22. The medium of claim 21 wherein the one or more code segments configured to generate the application estimate model comprises one or more code segments configured to generate one or more of a business rule services model, a visual services model, a data exchange services model, a user-oriented design session model, a commercial-off-the-shelf interface services model, a World Wide Web services model, a decision support services model, and output services model.

23. The medium of claim 20 wherein the one or more code segments configured to receive at least one of the one or more level of effort estimates comprises one or more code segments configured to receive a level of effort estimate associated with developing an object class.

24. The medium of claim 23 wherein the one or more code segments configured to receive at least one of the one or more level of effort estimates associated with developing an object class comprises one or more code segments configured to receive a level of effort estimate associated with developing a method associated with an object class.

25. The medium of claim 20 wherein the one or more code segments configured to receive at least one of the one or more level of effort estimates comprises one or more code segments configured to receive a level of effort estimate associated with developing a visual interface.

26. The medium of claim 20 wherein the one or more code segments configured to receive at least one of the one or more level of effort estimates comprises one or more code segments configured to receive a level of effort estimate associated with developing an interface to a computer system.

27. The medium of claim 20 wherein the one or more code segments configured to receive at least one of the one or more level of effort estimates comprises one or more code segments configured to receive a level of effort estimate associated with configuring a device.

28. The medium of claim 20 wherein the one or more code segments configured to receive at least one of the one or more level of effort estimates comprises one or more code segments configured to receive a level of effort estimate associated with engineering, designing or implementing one or more network devices for a site.

29. The medium of claim 20 wherein the one or more code segments configured to receive at least one of the one or more level of effort estimates comprises one or more code segments configured to receive a level of effort estimate associated with managing or monitoring a device.

30. The medium of claim 20 wherein the one or more code segments configured to receive at least one of the one or more level of effort estimates comprises one or more code segments configured to receive a level of effort estimate associated with performing configuration management for a device.

31. The medium of claim 30 wherein the one or more code segments configured to receive at least one of the one or more level of effort estimates comprises one or more code segments configured to receive a level of effort estimate associated with one or more of repairing a device, replacing a device, moving a device, adding a device, and modifying the configuration of a device.

32. The medium of claim 20 wherein the one or more code segments configured to receive at least one of the one or more level of effort estimates comprises one or more code segments configured to receive a level of effort estimate associated with providing security for a collection of information, or site as a device.

33. The medium of claim 20 wherein the one or more code segments configured to receive at least one of the one or more level of effort estimates comprises one or more code segments configured to receive a level of effort estimate associated with defining a security policy.

34. A system for estimating a level of effort required for developing an object-oriented system, the system comprising a processor connected to a storage device and one or more input/output devices, wherein the processor is configured to:
receive estimating information at one or more computer systems;
receive one or more level of effort estimates at one or more of the one or more computer systems, with each level of effort estimate being associated with an aspect or activity associated with developing an object-oriented system;
accumulate the one or more level of effort estimates received using at least one of the one or more computer systems;
generate one or more estimate models using the accumulated level of effort estimates and at least one of the one or more computer systems; and
repeat the accumulating of the one or more level of effort estimates and the generating of the one or more estimate models as more estimating information is provided.

35. The system of claim 34 wherein the processor is configured to generate one or more estimate models by generating one or more of an application estimate model, a business estimate model, an information model estimate model, a security estimate model, an infrastructure estimate model, a system management estimate model, and an enterprise estimate model.

36. The system of claim 35 wherein the processor is configured to generate the application estimate model by generating one or more of a business rule services model, a visual services model, a data exchange services model, a user-oriented design session model, a commercial-off-the-shelf interface services model, a World Wide Web services model, a decision support services model, and output services model.

37. The system of claim 34 wherein the processor is configured to receive at least one of the one or more level of effort estimates by receiving a level of effort estimate associated with developing an object class.

38. The system of claim 37 wherein the processor is configured to receive at least one of the one or more level of effort estimates associated with developing an object class by receiving a level of effort estimate associated with developing a method associated with an object class.

39. The system of claim 34 wherein the processor is configured to receive at least one of the one or more level of effort estimates by receiving a level of effort estimate associated with developing a visual interface.

40. The system of claim 34 wherein the processor is configured to receive at least one of the one or more level of effort estimates by receiving a level of effort estimate associated with developing an interface to a computer system.

41. The system of claim 34 wherein the processor configured to receive at least one of the one or more level of effort estimates comprises a processor configured to receive a level of effort estimate associated with configuring a device.

42. The system of claim 34 wherein the processor configured to receive at least one of the one or more level of effort estimates comprises a processor configured to receive a level of effort estimate associated with engineering, designing or implementing one or more network devices for a site.

43. The system of claim 34 wherein the processor configured to receive at least one of the one or more level of effort estimates comprises a processor configured to receive a level of effort estimate associated with managing a device.

44. The system of claim 34 wherein the processor configured to receive at least one of the one or more level of effort estimates comprises a processor configured to receive a level of effort estimate associated with performing configuration management for a device.

45. The system of claim 44 wherein the processor configured to receive at least one of the one or more level of effort estimates comprises a processor configured to receive a level of effort estimate associated with one or more of repairing a device, replacing a device, moving a device, adding a device, and modifying the configuration of a device.

46. The system of claim 34 wherein the processor configured to receive at least one of the one or more level of effort estimates comprises a processor configured to receive a level of effort estimate associated with providing security for a collection of information.

47. The system of claim 34 wherein the processor configured to receive at least one of the one or more level of effort estimates comprises a processor configured to receive a level of effort estimate associated with defining a security policy.
